(19) United States
(12) Patent Application Publication
(10) Pub. No.: US 2022/0150923 A1
(43) Pub. Date: May 12, 2022

(54) TERMINAL AND METHOD EXECUTED BY TERMINAL

(71) Applicant: NTT DOCOMO, INC., Tokyo (JP)

(72) Inventors: Yanru Wang, Beijing (CN); Huan Wang, Beijing (CN); Xiaolin Hou, Beijing (CN)

(73) Assignee: NTT DOCOMO, INC., Tokyo (JP)

(21) Appl. No.: 17/603,503

(22) PCT Filed: Apr. 17, 2019
(86) PCT No.: PCT/CN2019/083059

§ 371 Date: Oct. 13, 2021

(51) Int. Cl. H04W 72/12; H04W 72/00; H04W 72/04

(52) U.S. Cl. CPC H04W 72/1263; H04W 72/0446; H04W 72/005

(57) ABSTRACT

The present disclosure provides a terminal and a method executed by the terminal. The terminal includes: a receiving unit for receiving a sidelink state message from another terminal, the sidelink state message at least comprising a message of available sidelinks for another terminal except for the link with the terminal; and a processing unit for determining a plurality of links available for the terminal based on the received sidelink state message.

### TECHNICAL FIELD

The present disclosure relates to a field of wireless communication, and more particularly to a terminal and a method performed by a terminal.

### BACKGROUND

In order to improve spectrum utilization of a communication system, a Device-to-Device (D2D) communication technology has been proposed. In D2D communication, data can be directly transmitted between terminals without through network-side devices such as base stations, thereby reducing latency, increasing network capacity, and improving spectrum utilization.

In addition, in order to improve safety and intelligence of a transportation system, Internet of Vehicles (e.g., Vehicle to Everything, V2X) has been proposed. V2X requires low communication latency and large network capacity between vehicles. Since D2D technology has great advantages in latency and network capacity, D2D technology is used as a basic support technology of V2X.

In NR, regarding scheduling of sidelink (SL) resources between terminals communicating in V2X, two different approaches have been proposed: a first approach is that a terminal performing sidelink transmission selects resources autonomously; a second approach is to perform resource scheduling by a third-party scheduling device (e.g., a wireless base station or other terminal). FIGS. 1A and 1B are schematic diagrams showing resource scheduling in the second approach.

FIG. 1A shows a Uu (UE-UTRAN)-based sidelink resource scheduling approach. As shown in FIG. 1A, a wireless communication system 100 includes a base station 101, a terminal 102, and a terminal 103. In this transmission mode, sidelink transmission is performed between the terminal 102 and the terminal 103, and the base station 101 schedules SL resources for the terminal 102 performing sidelink transmission.

FIG. 1B shows a resource scheduling approach in which a third-party terminal schedules sidelink resources. As shown in FIG. 1B, a wireless communication system 110 includes a terminal 111, a terminal 112, and a terminal 113. In this transmission mode, sidelink transmission is performed between the terminal 112 and the terminal 113, and the terminal 111 schedules SL resources for the terminal 112 performing sidelink transmission.

In the examples shown in FIG. 1A and FIG. 1B, the description is made by taking the example that two terminals communicate directly without via other nodes (e.g., other terminal devices). In recent years, an approach has also been proposed in which a terminal serving as a transmission point and a terminal serving as a receiving point may communicate by taking other terminals as intermediate nodes, that is, a multi-hop communication approach. However, in an existing Internet of Vehicles communication system, a terminal can only know other terminals with which it directly performs sidelink communication (i.e., communication in a single-hop (1-hop) manner), but cannot determine whether a multi-hop link is available or not. Thus, a scheduling device cannot perform resource scheduling for the multi-hop link, either.

### SUMMARY OF THE DISCLOSURE

According to an aspect of the present disclosure, there is provided a terminal, comprising: a receiving unit for receiving a sidelink state message from another terminal, the sidelink state message of the other terminal including information about available sidelinks of the other terminal; and a processing unit for determining an available multi-hop link of the terminal based on the received sidelink state message.

According to an example of the present disclosure, a sidelink state message of each terminal includes at least ID information of the terminal and information about sidelinks of more than 1 hop available to the terminal.

According to an example of the present disclosure, the processing unit determines sidelink state message of the terminal itself, the terminal further comprising: a transmitting unit for transmitting the determined sidelink state message of the terminal itself.

According to an example of the present disclosure, the transmitting unit transmits the sidelink state message of the terminal itself in a time period that occurs periodically.

According to an example of the present disclosure, each said time period is divided into a plurality of slots, the transmitting unit transmits the sidelink state message of the terminal itself in one of the plurality of slots.

According to an example of the present disclosure, a length of the time period is configured according to a number of terminals to exchange sidelink state messages with each other.

According to an example of the present disclosure, the processing unit determines resources for transmitting the sidelink state message of the terminal itself.

According to an example of the present disclosure, the transmitting unit transmits the sidelink state message of the terminal itself determined by the processing unit to a resource scheduling device.

According to an example of the present disclosure, the transmitting unit transmits the sidelink state message of the terminal itself to the resource scheduling device through high layer signaling.

According to another aspect of the present disclosure, there is provided a method performed by a terminal, comprising: receiving a sidelink state message from another terminal, the sidelink state message of the other terminal including information about available sidelinks of the other terminal; and determining an available multi-hop link of the terminal based on the received sidelink state message.

According to an example of the present disclosure, a sidelink state message of each terminal includes at least ID information of the terminal and information about sidelinks of more than 1 hop available to the terminal.

According to an example of the present disclosure, a sidelink state message of the terminal itself is determined, and the determined sidelink state message of the terminal itself is transmitted.

According to an example of the present disclosure, the sidelink state message of the terminal itself is transmitted in a time period that occurs periodically.

According to an example of the present disclosure, each said time period is divided into a plurality of slots, and the sidelink state message of the terminal itself is transmitted in one of the plurality of slots.

According to an example of the present disclosure, a length of the time period is configured according to a number of terminals to exchange sidelink state messages with each other.

According to an example of the present disclosure, resources for transmitting the sidelink state message of the terminal itself is determined.

According to an example of the present disclosure, the terminal transmits the sidelink state message of the terminal itself to a resource scheduling device.

According to an example of the present disclosure, the sidelink state message of the terminal itself is transmitted to the resource scheduling device through high layer signaling.

### BRIEF DESCRIPTION OF THE DRAWINGS

The above and other objectives, features and advantages of the present disclosure will become more apparent by describing embodiments of the present disclosure in more details in conjunction with accompanying drawings. The accompanying drawings are used to provide a further understanding of the embodiments of the present disclosure, constitute a part of this specification, and explain the present disclosure together with the embodiments of the present disclosure, but do not constitute a limitation on the present disclosure. In the accompanying drawings, like reference numerals usually represent like components or steps.

FIGS. 1A and 1B are schematic diagrams showing resource scheduling modes in sidelink transmission.

FIG. 2 is a schematic diagram of a multi-hop link between terminals in V2X communication.

FIG. 3 is a flowchart of a method performed by a terminal according to an embodiment of the present disclosure.

FIGS. 4A and 4B are schematic diagrams of a multi-hop link according to an embodiment for explaining the present disclosure.

FIG. 5 is an example of a broadcast transmission manner of a sidelink state message according to an embodiment of the present disclosure.

FIG. 6 is a schematic diagram showing a request for resources for transmitting a sidelink state message.

FIG. 7 is a schematic structural diagram of a terminal according to an embodiment of the present disclosure.

FIG. 8 is a schematic diagram of a hardware structure of an involved device according to an embodiment of the present disclosure.

### DESCRIPTION OF THE EMBODIMENTS

In order to make objectives, technical solutions and advantages of the present disclosure more apparent, exemplary embodiments according to the present disclosure will be described in detail below with reference to the accompanying drawings. Like reference numerals represent like elements throughout the accompanying drawings. It should be understood that the embodiments described herein are merely illustrative and should not be construed as limiting the scope of the present disclosure. In addition, the terminals described herein may include various types of terminals, such as a vehicle terminal, a user equipment (UE), a mobile terminal (or referred to as a mobile station), or a fixed terminal.

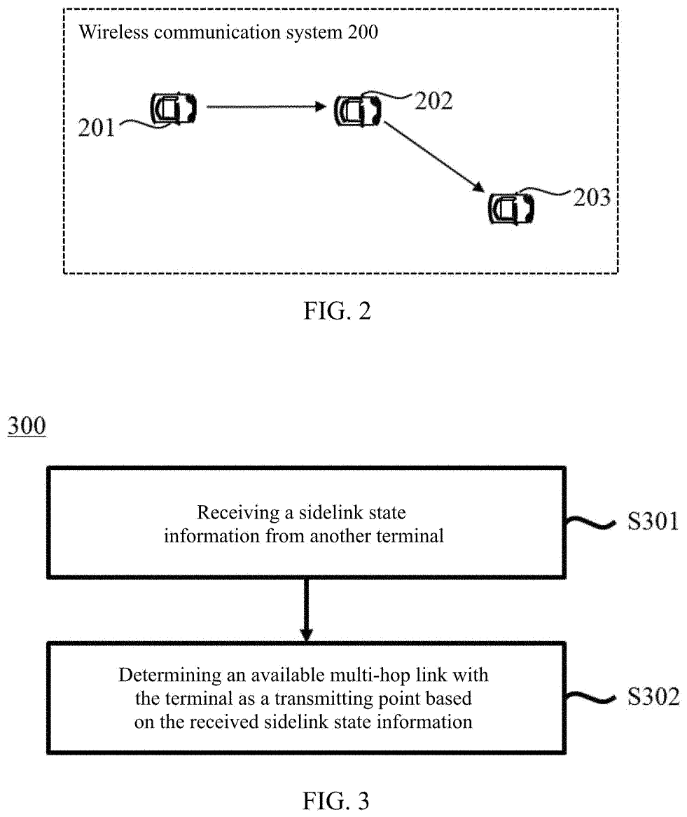

FIG. 2 schematically illustrates a multi-hop link between terminals in V2X communication. As shown in FIG. 2, in a wireless communication system 200, a terminal 201, a terminal 202, and a terminal 203 perform SL communication. The terminal 201 directly performs SL transmission with the terminal 202, the terminal 202 directly performs SL transmission with the terminal 203, and the terminal 201 performs SL transmission with the terminal 203 via the terminal 202 by using the terminal 202 as an intermediate node. In this case, a sidelink between the terminal 201 and the terminal 203 is a multi-hop link, specifically, a 2-hop link. Correspondingly, sidelinks between the terminal 201 and the terminal 202, and between the terminal 202 and the terminal 203 are single-hop links (1-hop).

It should be appreciated that FIG. 2 only illustrates the case of 2-hop SL transmission with sidelink transmission between two terminals via another terminal, but this is only schematic. In the wireless communication system of FIG. 2, transmissions between terminals performing SL transmission may also be realized via more than two terminals (intermediate nodes), and at this time, a link between the terminals performing SL transmission is an (n+1)-hop link.

In the example shown in FIG. 2, the terminal 201 can determine a terminal with which it directly communicates, that is, the terminal 202, but the terminal 201 cannot know whether it has an available multi-hop link. For example, the terminal 201 cannot know availability of the 2-hop link between it and the terminal 203. That is, in the existing communication system, how to determine availability of a multi-hop link is unknown.

In view of the above problem, the present disclosure hopes to provide a terminal and a method for a terminal, so that when multi-hop SL transmission is performed, an available multi-hop link can be determined.

The method performed by a terminal according to an embodiment of the present disclosure will be explained below with reference to FIG. 3. FIG. 3 is a flowchart of a method 300 performed by a terminal according to an embodiment of the present disclosure. As shown in FIG. 3, in step S301, a sidelink state message from another terminals is received, and the sidelink state messages of the other terminal includes information about available sidelinks of the other terminal. For example, the sidelink state message of the other terminal may include information about a link between the other terminal and the terminal performing the method 300, and may further include information about available sidelinks of the other terminal other than the link between the terminal performing the method 300. In addition, according to an example of the present disclosure, a sidelink state message of each terminal includes at least ID information of the terminal and information about sidelinks of more than 1 hop available to the terminal.

Then, according to step S302, based on the received sidelink state message, an available multi-hop link of the terminal is determined.

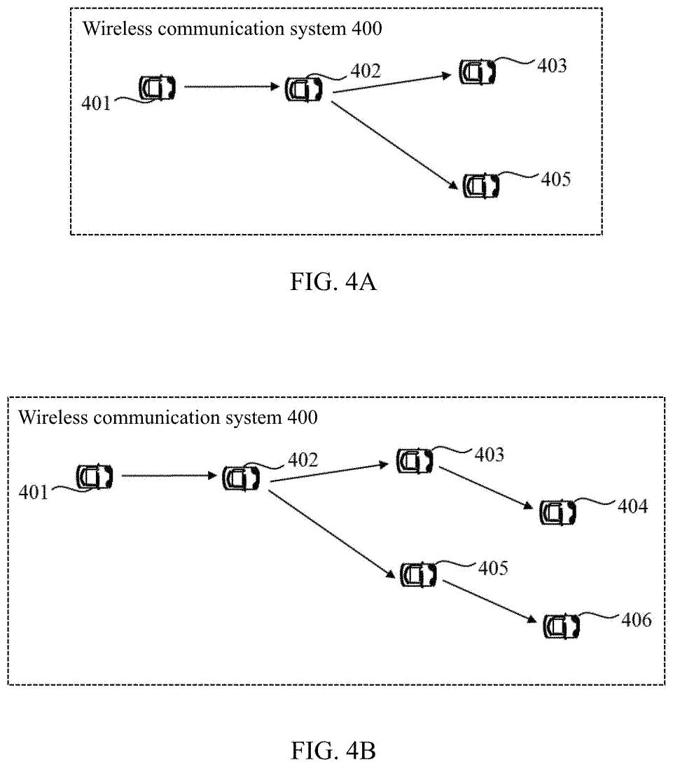

Specific examples of the method shown in FIG. 3 will be further described below in conjunction with schematic diagrams of links shown in FIG. 4A and FIG. 4B.

### Example 1 for Determining a Multi-Hop Link

In the example shown in FIG. 4A, a terminal 401 firstly receives a sidelink state message from a terminal 402 according to step S301.

In the sidelink state message from the terminal 402, ID information of the terminal 402 and information about available sidelinks of the terminal 402 other than the link with the terminal 401 are included. For example, in the example shown in FIG. 4A, the information about available sidelinks is information about the single-hop link between the terminal 402 and the terminal 403 and information about the single-hop link between the terminal 402 and the terminal 405.

According to an example of this embodiment, the information about the single-hop links between the terminal 402 and the terminal 403, the terminal 405 is, for example, ID information of the terminal 403 and the terminal 405.

Then, according to step S302, the terminal 401 determines an available multi-hop sidelink of the terminal 401 based on the sidelink state message from the terminal 402. As described above, in the example shown in FIG. 4A, a processing unit of the terminal 401 determines that the terminal 401 may communicate with the terminal 403 or the terminal 405 via a 2-hop link according to the information about the single-hop links between the terminal 402 and the terminal 403, the terminal 405 received from the terminal 402, and intermediate nodes passed by the two 2-hop links are both the terminal 402.

### Example 2 for Determining a Multi-Hop Link

In the example shown in FIG. 4A, the sidelink state message of the other terminal including single-hop link information of the other terminal is taken as an example for description. A more complicated example will be described below in conjunction with FIG. 4B.

As shown in FIG. 4B, it is assumed that there is a further available single-hop sidelink between the terminal 403 and a terminal 404. Then, referring to the above content, the terminal 402 may determine one available 2-hop link with the terminal 404, and an intermediate node passed by the 2-hop link is the terminal 403. Similarly, based on the same steps, the terminal 402 may determine that a 2-hop link with a terminal 406 via the terminal 405 is also available.

As described above, the sidelink state message received by the terminal 401 from the terminal 402 according to step S301 includes the ID information of the terminal 402 and the information about available sidelinks of the terminal 402. At this time, these available sidelinks include the single-hops link between the terminal 402 and the terminal 403, the terminal 405, and the 2-hop links between the terminal 402 and the terminals 404, 406 via the terminal 403, the terminal 405 respectively.

As described above, information about the aforementioned available single-hop links may be, for example, the ID information of the terminal 402 and the terminal 405. According to an example of this embodiment, information about the aforementioned available 2-hop links is, for example, information that associates ID information of the terminal 403 (terminal 405) and the terminal 404 (terminal 406) sequentially in any method. For example, the terminal 402 may form the following link terminal table shown in Table 1 according to its single-hop link information and 2-hop link information, and transmit a sidelink state message indicating the link terminal table:

TABLE 1
Link terminal table of the terminal 402

| Single-hop terminal | 2-hop terminal |
|---|---|
| Terminal 403 ID | Terminal 404 ID |
| Terminal 405 ID | Terminal 406 ID |

The terminal 401 may learn the following information according to the sidelink state message of the terminal 402: there is an available single-hop link between the terminal 401 itself and the terminal 402; there is an available single-hop link between the terminal 402 and the terminal 403, the terminal 405, respectively; there is an available 2-hop link between the terminal 402 and the terminal 404; an intermediate node passed by the 2-hop link between the terminal 402 and the terminal 404 is the terminal 403; there is an available 2-hop link between the terminal 402 and the terminal 404; an intermediate node passed by the 2-hop link between the terminal 402 and the terminal 406 is the terminal 405.

Thus, according to step S302, the terminal 401 determines, according to the ID information and the link terminal table of the terminal 402, that available sidelinks of the terminal 401 are: the single-hop link between the terminal 401 and the terminal 402; the 2-hop link between the terminal 401 and the terminal 403 via the terminal 402; the 3-hop link between the terminal 401 and the terminal 404 via the terminal 402 and the terminal 403 in turn; the 2-hop link between the terminal 401 and the terminal 405 via the terminal 402; the 3-hop link between the terminal 401 and the terminals 406 via the terminal 405 and the terminal 406 in turn.

Similarly, when the sidelink information received by the terminal 401 from the terminal 402 further includes information about 3-hop links, 4-hop links or even n-hop links available to the terminal 402, the terminal 401 may determine that 4-hop links, 5-hop links or even (n+1)-hop links with the terminal 402 as one of the intermediate nodes is available.

In addition, according to another example of the present invention, the number of multi-hop links available to the terminal, the number of nodes in each multi-hop link, etc. may be configured, to avoid the multi-hop link table that the terminal needs to maintain is too large, resulting in issues such as communication latency. For example, the link terminal table may be made to record ID information of terminals in 5-hop links at most.

It should be noted that the link terminal table is only an example of the present disclosure. As long as availability of sidelinks can be expressed, other arbitrary data structure manners may be used instead of the table.

In the method described above in conjunction with FIG. 3, FIG. 4A, and FIG. 4B, a terminal can determine its own available multi-hop sidelinks according to a sidelink state message from another terminal.

In addition, according to an example of this embodiment, in addition to receiving sidelink information to determine multi-hop links available to itself, the terminal may also transmit its own sidelink state message, so that other terminals may determine multi-hop links of the other terminals according to the sidelink state message. In this case, the method described in FIG. 3 may further include determining the sidelink state message of the terminal itself, and transmitting the sidelink state message of the terminal itself. For example, the sidelink state message of the terminal itself includes ID information of the terminal itself and information about sidelinks of more than 1 hop available to the terminal. As another example, the transmission may be performed by broadcasting.

According to an example of this embodiment, in a V2X communication network, a terminal in a set resource pool/band domain/carrier/frequency etc. may be configured as a terminal that broadcasts its own sidelink state message. That is, in a communication system, a terminal that needs to broadcast a sidelink state message may be (pre-)set.

Still taking FIG. 4B as an example to describe the foregoing transmission. As described above, the terminal 401 in FIG. 4B has determined its available single-hop links, 2-hop links, and 3-hop links by step S302. Next, the terminal 401 determines the sidelink state message of the terminal 401 based on these links.

In an example, the sidelink state message to be determined by the terminal 401 includes ID information of the terminal 401 and information about sidelinks available to the terminal 401. The available sidelink information may be, for example, information obtained by sequentially saving ID information of terminals passed by in respective sidelinks in association. In this example, it is determined as follows:

the terminal 401 writes the ID information of the terminal 402 into its sidelink state message, and thus the sidelink state message contains information about an available single-hop link of the terminal 401; writes information of the terminal 402 into its own sidelink state message in association with information about available single-hop links of the terminal 402, and thus the sidelink state message contains information about available 2-hop links of the terminal 401; writes information of the terminal 402 into its own sidelink state message in association with information about available 2-hop links of the terminal 402, and thus the sidelink state message contains information about available 3-hop links of the terminal 401.

Similarly, the information about these available sidelinks may be expressed in the sidelink state message in the form of a link terminal table, as shown below:

TABLE 2
Link terminal table of the terminal 401

| Single-hop terminal | 2-hop terminal | 3-hop terminal |
|---|---|---|
| Terminal 402 ID | Terminal 403 ID | Terminal 404 ID |
| Terminal 402 ID | Terminal 405 ID | Terminal 406 ID |

According to another example of the present invention, each time a sidelink state message from another terminal is received, the terminal may determine its own available links based on a link terminal table contained in the sidelink state message of the other terminal, update its own link terminal table, and optionally, may transmit a sidelink state message containing the updated own link terminal table. Therefore, even if other terminals increase or decrease, the terminal can update the determined available multi-hop sidelinks.

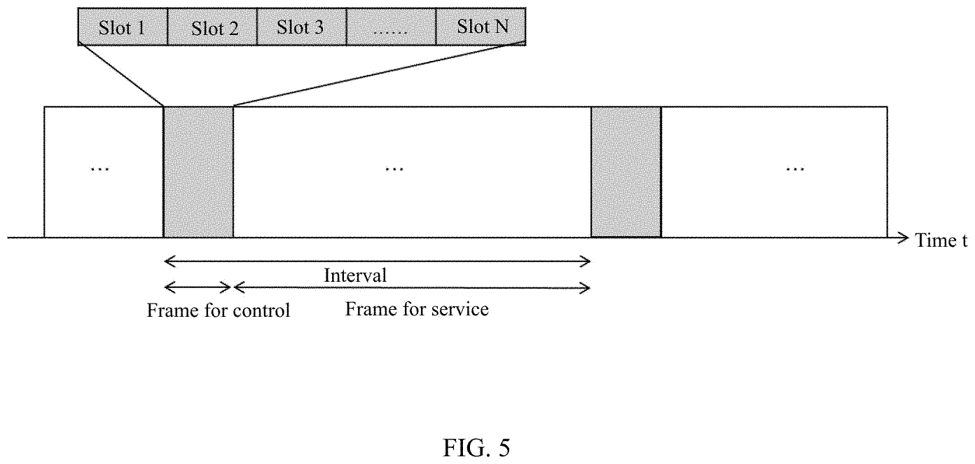

In addition, according to an example of this embodiment, the sidelink state message broadcasted by the terminal may be periodically transmitted, and a period of the broadcast transmission may be (pre-)set. This example will be specifically explained with reference to FIG. 5.

First, resources in the time domain are divided in the manner shown in FIG. 5, and time-domain resources are divided into a plurality of continuous intervals. A length of a divided interval may be (pre-)set, and a starting point of each interval may be (pre-)set by an offset.

Then, each interval is further divided into a time period for control and a time period for service. These two time periods may be referred to as frames, subframes, symbols, slots, mini-slots or the like. Hereinafter, for the convenience of description, they are referred to as a frame for control and a frame for service, respectively.

A starting point of the frame for control may also coincide with the starting point of the aforementioned interval, and thus, as shown in FIG. 5, the frame for control and the frame for service are alternately continuous in the time domain. It may be set to transmit the sidelink state message in the frame for control, and at this time, the sidelink state message is transmitted periodically.

In the frame for control, in addition to transmitting the sidelink state message, emergency information transmission or signaling may also be transmitted. The emergency information is, for example, information representing an emergency situation encountered by a vehicle terminal; the signaling is, for example, signaling for resource allocation in a service channel.

In addition, as shown in FIG. 5, in an example, the frame for control is divided into N continuous slots, and in each slot, the terminal broadcasts the sidelink state message. Specifically, each terminal to exchange sidelink state messages in a same V2X communication network is allocated one slot, and the terminal broadcasts the sidelink state message in each allocated slot. Therefore, in order that all terminals that need to broadcast sidelink state messages will be allocated slots for transmission, the number of slots N should be greater than or equal to the number of terminals that need to broadcast.

In an example, a length of the frame for control may be configured. For example, the length of the frame for control may be configured according to the number of terminals that need to perform broadcast transmission. Specifically, when the length of each divided slot is determined, the number of slots N varies with the number of terminals in a same V2X network that need to broadcast, so that the length of the frame for control is configured according to the number N.

Alternatively, the terminal may also non-periodically broadcast the sidelink state message as required. Specifically, the broadcast transmission is performed non-periodically according to a network indication or a network configuration.

Next, how to allocate resources for transmitting the sidelink state message will be explained. In the case that a third-party scheduling device (a radio base station and other terminals) schedules SL resources, the scheduling device may also allocate resources for transmitting the sidelink state message; and in the case that a terminal performing SL transmission selects SL resources itself, the terminal may also autonomously select resources for transmitting the sidelink state message, for example, it may perform a contention-based resource selection before transmission.

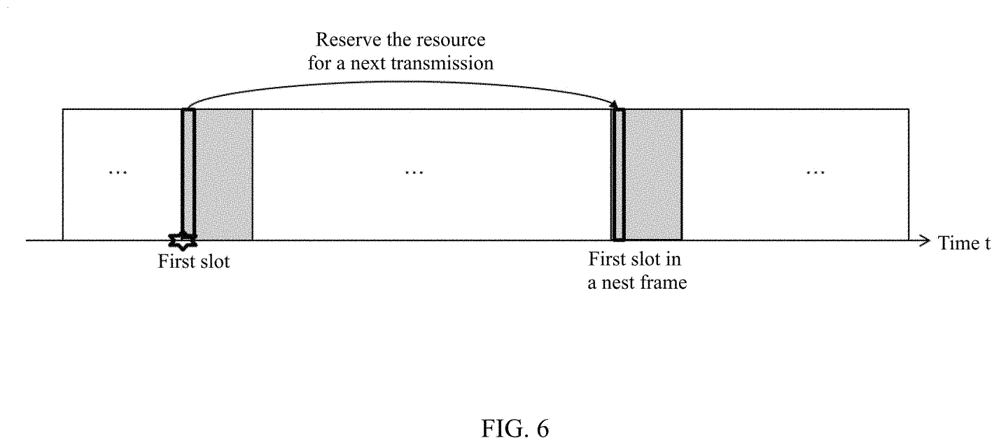

In conjunction with FIG. 6, a method in which the terminal autonomously selects resources for transmitting the sidelink state message in the case of periodically transmitting the sidelink state message will be explained.

In FIG. 6, the terminal autonomously selects a resource for transmitting the sidelink state message, and when transmitting the sidelink state message, reserves the resource for transmitting the sidelink state message this time for a next transmission of the sidelink state message. The terminal may transmit the reservation information together with the sidelink state message. As shown in FIG. 6, the terminal transmits the sidelink state message in a first slot of a frame for control, and reserves the resource used for transmitting the sidelink state message this time, so that it may be used for a next transmission in a first slot of a next frame for control. By exchanging resource reservation information, each terminal may learn about a resource reservation situation for transmitting sidelink state messages.

In an example, for resources for transmitting sidelink state messages, no matter which allocation method is adopted, a resource set may be allocated. In this resource set, transmission repetition or beam-based transmission may be performed.

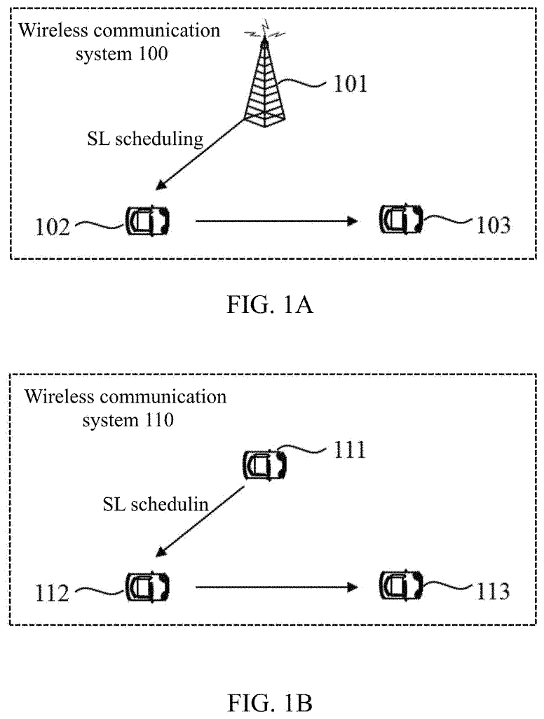

According to the above description, for scheduling of SL transmission resources, when the terminal performing SL transmission selects resources autonomously, since the terminal has determined available multi-hop links with the above method, it may perform corresponding resource selection. However, in the case of resource scheduling performed by a third-party scheduling device as shown in FIGS. 1A and 1B, since the scheduling device does not yet know a situation about available sidelinks, resource scheduling cannot be performed smoothly.

In view of the foregoing problem, according to an example of this embodiment, the method 300 may further include the following step: the terminal transmits its own determined sidelink state message to the scheduling device (a wireless base station or a third-party terminal as a scheduling point).

According to an example of this embodiment, the sidelink state message transmitted by the terminal to the scheduling device includes its own ID information and a link terminal table.

According to an example of this embodiment, the terminal may transmit its own sidelink state message to the scheduling device according to configuration information. Specifically, in a V2X communication network, a terminal in a set resource pool/band domain/carrier/frequency, etc. may be (pre-set) as the terminal that transmit a sidelink state message to the scheduling device.

According to an example of this embodiment, when there are a plurality of scheduling devices for SL resource scheduling (for example, there are a plurality of third-party terminals for resource scheduling) in a V2X communication network, the sidelink state message is transmitted to each scheduling device.

According to an example of this embodiment, the terminal may periodically transmit the sidelink state message to the scheduling device. And, a period of the broadcast may be (pre-)set.

According to another example of this embodiment, the terminal may transmit the sidelink state message to the scheduling device non-periodically. Specifically, broadcast transmission is performed non-periodically according to a network indication or a network configuration. For example, transmission may be performed non-periodically according to an update situation of the sidelink state message, that is, each time after the terminal updates its own sidelink state message based on received sidelink state messages of other terminals, it transmits the updated sidelink state message to the scheduling device, otherwise not.

According to an example of this embodiment, when the scheduling device is a base station, the terminal transmits the sidelink state message to the base station in an uplink by using high layer signaling (e.g., Radio Resource Control (RRC) signaling).

According to another example of this embodiment, when the scheduling device is another terminal, the terminal transmits the sidelink state message to the other terminal in a sidelink by using high layer signaling (e.g., RRC-like signaling).

According to another example of this embodiment, the terminal may transmit the sidelink state message to the scheduling device by using physical layer signaling.

Thus, according to the above steps, the scheduling device (a wireless base station or a third-party terminal as a scheduling point) can grasp the situation about available sidelinks in the V2X communication network, so as to perform resource scheduling smoothly.

A terminal according to an embodiment of the present disclosure will be described below with reference to FIG. 7. FIG. 7 is a schematic structural diagram of a terminal 700 according to an embodiment of the present disclosure. As shown in FIG. 7, the terminal 700 includes a receiving unit 710 that receives a sidelink state message from another terminal, and the sidelink state message of the other terminal include information about available sidelinks of the other terminal. For example, the sidelink state message of the other terminal may include information about a link between the other terminal and the terminal 700, and in addition, may further include information about available sidelinks of the other terminal other than the link with the terminal 700. In addition, according to an example of the present disclosure, a sidelink state message of each terminal includes at least ID information of the terminal and information about sidelinks of more than 1 hop available to the terminal.

The terminal 700 further includes a processing unit 720, which determines an available multi-hop link of the terminal based on the received sidelink state message. In addition to these units, the terminal 700 may further include other components. However, since these components are irrelevant to the content of the embodiments of the present disclosure, their illustrations and descriptions are omitted herein.

In an example, the sidelink state message received by the receiving unit 700 from the other terminal includes the ID information of the other terminal and information about available single-hop links of the other terminal. If the other terminal is used as a transmitting end, the information about single-hop links is, for example, ID information of terminals serving as receiving ends.

The processing unit 720 determines, based on the sidelink state message received by the receiving unit 710, that 2-hop sidelinks between the terminal 700 and the aforementioned terminals serving as receiving points via the other terminal are available.

In another example, the sidelink state message received by the receiving unit 710 from the other terminal includes the ID information of the other terminal and information about an available n-hop link of the other terminal. Similarly, the processing unit 720 may determine, based on the sidelink state message, availability of an (n+1)-hop sidelink of the terminal 700 with the other terminal as an intermediate node.

In addition, according to an example of the above embodiment, the terminal 700 may further include a transmitting unit 730 for transmitting its own sidelink state message, so that other terminals may determine multi-hop links of the other terminals according to the sidelink state message. In this case, the processing unit 720 determines its own sidelink state message; the transmitting unit 730 transmits the sidelink state message of the terminal 700 determined by the processing unit 720. In one example, the transmission may be performed by broadcasting.

In addition, the terminal 700 that performs the aforementioned broadcast transmission may be (pre-)set. Specifically, in a V2X communication network, a terminal in a set resource pool/band domain/carrier/frequency, etc. may be (pre-set) as the terminal that performs broadcast transmission.

According to an example of the present disclosure, the sidelink state message to be determined by the processing unit 720 includes ID information of the terminal 700 and information about sidelinks available to the terminal 700. Specifically, the processing unit 710 sequentially writes ID information of each terminal passing by the determined available sidelinks of the terminal 700 into the sidelink state message in association.

In an example, the information about sidelinks available to the terminal 700 may be expressed in the form of a terminal link table:

TABLE 3
Link terminal table of the terminal 700

| Single-hop terminal | 2-hop terminal | 3-hop terminal |
|---|---|---|
| Terminal ID#0 | Terminal ID#1 | Terminal ID#3 |
| Terminal ID#0 | Terminal ID#2 | Terminal ID#4 |

In this table, availability of the following sidelinks of the terminal 700 is shown: the link for single-hop communication with the terminal of ID #0; the link for 2-hop communication with the terminal of ID #1 via the terminal of ID #0; the link for 2-hop communication with the terminal of ID #2 via the terminal of ID #0; the link for 3-hop communication link with the terminal of ID #3 via the terminal of ID #0 and the terminal of ID #1 in turn; the link for 3-hop communication link with the terminal of ID #4 via the terminal of ID #0 and the terminal of ID #2 in turn.

In the above example, the number of multi-hop links available to the terminal 700, the number of nodes in each multi-hop links, etc., may be configured, to avoid the multi-hop link table that the terminal needs to maintain is too large, resulting in issues such as communication latency. For example, the link terminal table may be made to record ID information of terminals in 5-hop links at most.

It should be noted that the link terminal table is only an example of the present disclosure. As long as availability of sidelinks can be expressed, other arbitrary data structure manners may be used instead of the table.

According to an example of the present invention, whenever the receiving unit 710 receives a sidelink state message from another terminal, the processing unit 720 may determine its own available links and update its own link terminal table based on the link terminal table contained in the sidelink state message of the other terminal, and optionally, the transmitting unit 730 transmits a sidelink state message including the updated own link terminal table.

In an example, the sidelink state message broadcasted by the transmitting unit 730 may be transmitted periodically. And, a period of the broadcast transmission may be (pre-)set. This example will be specifically explained with reference to FIG. 5.

First, resources in the time domain are divided in the manner shown in FIG. 5, and time-domain resources are divided into a plurality of continuous intervals. A length of a divided interval may be (pre-)set, and a starting point of each interval may be (pre-)set by an offset.

Then, each interval is further divided into a time period for control and a time period for service. These two time periods may be referred to as frames, subframes, symbols, slots, mini-slots or the like. Hereinafter, for the convenience of description, they are referred to as a frame for control and a frame for service, respectively.

A starting point of the frame for control may also coincide with the starting point of the aforementioned interval, and thus, as shown in FIG. 5, the frame for control and the frame for service are alternately continuous in the time domain. It may be set to transmit the sidelink state message in the frame for control, and at this time, the sidelink state message is transmitted periodically.

In the frame for control, in addition to transmitting the sidelink state message, emergency information transmission or signaling may also be transmitted. The emergency information is, for example, information representing an emergency situation encountered by a vehicle terminal; the signaling is, for example, signaling for resource allocation in a service channel.

In addition, as shown in FIG. 5, in an example, the frame for control is divided into N continuous slots, and in each slot, the sidelink state message is broadcasted. Specifically, each terminal to exchange sidelink state messages in a same V2X communication network is allocated one slot, and the terminal broadcasts the sidelink state message in each allocated slot. Therefore, in order that all terminals that need to broadcast sidelink state messages will be allocated slots for transmission, the number of slots N should be greater than or equal to the number of terminals that need to broadcast.

In an example, a length of the frame for control may be configured. For example, the length of the frame for control may be configured according to the number of terminals that need to perform broadcast transmission. Specifically, when the length of each divided slot is determined, the number of slots N varies with the number of terminals in a same V2X network that need to broadcast, so that the length of the frame for control is configured according to the number N.

In addition, in another example, the sidelink state message broadcasted by the transmitting unit 730 may also be transmitted non-periodically. Specifically, the broadcast transmission is performed non-periodically according to a network indication or a network configuration.

Next, how to allocate resources for transmitting the sidelink state message will be explained. In the case that a third-party scheduling device (a radio base station and other terminals) schedules SL resources, the scheduling device may also allocate resources for transmitting the sidelink state message; and in the case that the terminal 700 selects SL resources itself, the terminal 700 autonomously selects resources for transmitting the sidelink state message, for example, it may perform a contention-based resource selection before transmission.

In conjunction with FIG. 6, a method in which the terminal 700 autonomously selects resources for transmitting the sidelink state message in the case of periodically transmitting the sidelink state message will be explained.

In FIG. 6, when the transmitting unit 730 transmits its own available sidelink state message, the processing unit 720 reserves the resource for transmitting the sidelink state message this time for a next transmission of the sidelink state message. The transmitting unit 730 may transmit the reservation information together with the sidelink state message. As shown in FIG. 6, the transmitting unit 730 transmits the sidelink state message in a first slot of a frame for control, and the processing unit 730 reserves the resource used for transmitting the sidelink state message this time, so that it may be used by the transmitting unit 730 for a next transmission in a first slot of a next frame for control. By exchanging resource reservation information, each terminal may learn about a resource reservation situation for transmitting sidelink state messages.

In an example, for resources for transmitting sidelink state messages, no matter which allocation method is adopted, a resource set may be allocated. In this resource set, transmission repetition or beam-based transmission may be performed.

According to an example of the above embodiment, the transmitting unit 730 may also transmit its own determined sidelink state message to a scheduling device (a wireless base station or a third-party terminal as a scheduling point), so that the scheduling device schedules available sidelink resources of the terminal 700 based on the available sidelink information of the terminal 700.

In an example, the sidelink state message transmitted by the transmitting unit 730 to the scheduling device includes ID information of the terminal 700 and a link terminal table.

In an example, the terminal 700 may transmit its own sidelink state information to the scheduling device according to configuration information. Specifically, in a V2X communication network, a terminal in a set resource pool/band domain/carrier/frequency, etc. may be (pre-set) as the terminal that transmit a sidelink state message to the scheduling device.

According to an example of this embodiment, when there are a plurality of scheduling devices for SL resource scheduling (for example, there are a plurality of third-party terminals for resource scheduling) in a V2X communication network, the transmitting unit 730 transmits the sidelink state message to each scheduling device.

In an example, the transmitting unit 730 may periodically transmit the sidelink state message to the scheduling device. And, a period of the broadcast may be (pre-)set.

In another example, the transmitting unit 730 may transmit the sidelink state message to the scheduling device non-periodically. Specifically, broadcast transmission is performed non-periodically according to a network indication or a network configuration. For example, transmission may be performed non-periodically according to an update situation of the sidelink state message, that is, only after the processing unit 720 updates its own sidelink state message based on sidelink state messages of other terminals received by the receiving unit 710, the transmitting unit 730 transmits the updated sidelink state message to the scheduling device, otherwise not.

According to an example of this embodiment, when the scheduling device is a base station, the transmitting unit 730 transmits the sidelink state message to the base station in an uplink by using high layer signaling (e.g., Radio Resource Control (RRC) signaling).

According to another example of this embodiment, when the scheduling device is another terminal, the terminal transmits the sidelink state message to the other terminal in a sidelink by using high layer signaling (e.g., RRC-like signaling).

According to another example of this embodiment, the transmitting unit 730 may transmit the sidelink state message to the scheduling device by using physical layer signaling.

<Hardware Structure>

In addition, block diagrams used in the description of the above embodiments illustrate blocks in units of functions. These functional blocks (structural blocks) may be implemented in arbitrary combination of hardware and/or software. Furthermore, means for implementing respective functional blocks is not particularly limited. That is, the respective functional blocks may be implemented by one apparatus that is physically and/or logically jointed; or more than two apparatuses that are physically and/or logically separated may be directly and/or indirectly connected (e.g. via wire and/or wireless), and the respective functional blocks may be implemented by these apparatuses.

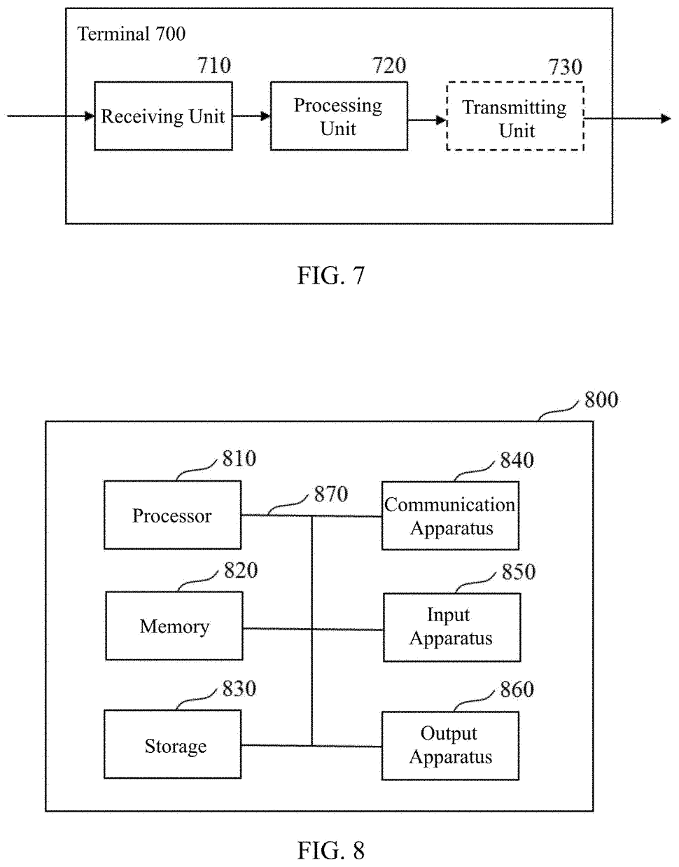

For example, a device (such as, a terminal, etc.) in an embodiment of the present disclosure may function as a computer that executes the processes of the wireless communication method of the present disclosure. FIG. 8 is a schematic diagram of a hardware structure of a device 800 (a terminal) involved in an embodiment of the present disclosure. The above device 800 (terminal) may be constituted as a computer apparatus that physically comprises a processor 810, a memory 820, a storage 830, a communication apparatus 840, an input apparatus 850, an output apparatus 860, a bus 870 and the like

In addition, in the following description, terms such as “apparatus” may be replaced with circuits, devices, units, and the like. The hardware structure of the terminal may include one or more of the respective apparatuses shown in the figure, or may not include a part of the apparatuses.

For example, only one processor 810 is illustrated, but there may be multiple processors. Furthermore, processes may be performed by one processor, or processes may be performed by more than one processor simultaneously, sequentially, or with other methods. In addition, the processor 810 may be installed by more than one chip.

Respective functions of any of the device 800 may be implemented, for example, by reading specified software (program) on hardware such as the processor 810 and the memory 820, so that the processor 810 performs computations, controls communication performed by the communication apparatus 840, and controls reading and/or writing of data in the memory 820 and the storage 830.

The processor 810, for example, operates an operating system to control the entire computer. The processor 810 may be constituted by a Central Processing Unit (CPU), which includes interfaces with peripheral apparatuses, a control apparatus, a computing apparatus, a register and the like. For example, the processing unit and the like described above may be implemented by the processor 810.

In addition, the processor 810 reads programs (program codes), software modules and data from the storage 830 and/or the communication apparatus 840 to the memory 820, and execute various processes according to them. As for the program, a program causing computers to execute at least a part of the operations described in the above embodiments may be employed. For example, the processing unit of the terminal 700 may be implemented by a control program stored in the memory 820 and operated by the processor 810, and other functional blocks may also be implemented similarly.

The memory 820 is a computer-readable recording medium, and may be constituted, for example, by at least one of a Read Only Memory (ROM), an Erasable Programmable ROM (EPROM), an Electrically EPROM (EEPROM), a Random Access Memory (RAM) and other appropriate storage media. The memory 820 may also be referred to as a register, a cache, a main memory (a main storage apparatus) and the like. The memory 820 may store executable programs (program codes), software modules and the like for implementing a method involved in an embodiment of the present disclosure.

The storage 830 is a computer-readable recording medium, and may be constituted, for example, by at least one of a flexible disk, a Floppy® disk, a magneto-optical disk (e.g., a Compact Disc ROM (CD-ROM) and the like), a digital versatile disk, a Blu-ray® disk, a removable disk, a hard driver, a smart card, a flash memory device (e.g., a card, a stick and a key driver), a magnetic stripe, a database, a server, and other appropriate storage media. The storage 830 may also be referred to as an auxiliary storage apparatus.

The communication apparatus 840 is a hardware (transceiver device) performing communication between computers via a wired and/or wireless network, and is also referred to as a network device, a network controller, a network card, a communication module and the like, for example. The communication device 840 may include a high-frequency switch, a duplexer, a filter, a frequency synthesizer and the like to implement, for example, Frequency Division Duplex (FDD) and/or Time Division Duplex (TDD). For example, the transmitting unit, the receiving unit and the like described above may be implemented by the communication apparatus 840.

The input apparatus 850 is an input device (e.g., a keyboard, a mouse, a microphone, a switch, a button, a sensor and the like) that receives input from the outside. The output apparatus 860 is an output device (e.g., a display, a speaker, a Light Emitting Diode (LED) light and the like) that performs outputting to the outside. In addition, the input apparatus 850 and the output apparatus 860 may also be an integrated structure (e.g., a touch screen).

Furthermore, the respective apparatuses such as the processor 810 and the memory 820 are connected by the bus 870 that communicates information. The bus 870 may be constituted by a single bus or by different buses between the apparatuses.

Furthermore, the terminal may comprise hardware such as a microprocessor, a Digital Signal Processor (DSP), an Application Specified Integrated Circuit (ASIC), a Programmable Logic Device (PLD), a Field Programmable Gate Array (FPGA), etc., and the hardware may be used to implement a part of or all of the respective functional blocks. For example, the processor 810 may be installed by at least one of these hardware.

(Variations)

In addition, the terms illustrated in the present specification and/or the terms required for understanding of the present specification may be substituted with terms having the same or similar meaning. For example, a channel and/or a symbol may also be a signal (signaling). Furthermore, the signal may be a message. A reference signal may be abbreviated as an “RS”, and may also be referred to as a pilot, a pilot signal and so on, depending on the standard applied. Furthermore, a component carrier (CC) may also be referred to as a cell, a frequency carrier, a carrier frequency, and the like.

Furthermore, the information, parameters and so on described in this specification may be represented in absolute values or in relative values with respect to specified values, or may be represented by other corresponding information. For example, radio resources may be indicated by specified indexes. Furthermore, formulas and the like using these parameters may be different from those explicitly disclosed in this specification.

The names used for the parameters and the like in this specification are not limited in any respect. For example, since various channels (Physical Uplink Control Channels (PUCCHs), Physical Downlink Control Channels (PDCCHs), etc.) and information elements may be identified by any suitable names, the various names assigned to these various channels and information elements are not limitative in any respect.

The information, signals and the like described in this specification may be represented by using any one of various different technologies. For example, data, instructions, commands, information, signals, bits, symbols, chips, etc. possibly referenced throughout the above description may be represented by voltages, currents, electromagnetic waves, magnetic fields or particles, optical fields or photons, or any combination thereof.

In addition, information, signals and the like may be output from higher layers to lower layers and/or from lower layers to higher layers. Information, signals and the like may be input or output via a plurality of network nodes.

The information, signals and the like that are input or output may be stored in a specific location (for example, in a memory), or may be managed in a control table. The information, signals and the like that are input or output may be overwritten, updated or appended. The information, signals and the like that are output may be deleted. The information, signals and the like that are input may be transmitted to other apparatuses.

Reporting of information is by no means limited to the manners/embodiments described in this specification, and may be implemented by other methods as well. For example, reporting of information may be implemented by using physical layer signaling (for example, downlink control information (DCI), uplink control information (UCI)), higher layer signaling (for example, RRC (Radio Resource Control) signaling, broadcast information (master information blocks (MIBs), system information blocks (SIBs), etc.), MAC (Medium Access Control) signaling), other signals or combinations thereof.

In addition, physical layer signaling may also be referred to as L1/L2 (Layer 1/Layer 2) control information (L1/L2 control signals), L1 control information (L1 control signal) and the like. Furthermore, RRC signaling may also be referred to as RRC messages, for example, RRC connection setup messages, RRC connection reconfiguration messages, and so on. Furthermore, MAC signaling may be reported by using, for example, MAC control elements (MAC CEs).

Furthermore, notification of prescribed information (for example, notification of “being X”) is not limited to being performed explicitly, and may be performed implicitly (for example, by not performing notification of the prescribed information or by notification of other information).

Decision may be performed by a value (0 or 1) represented by 1 bit, or by a true or false value (Boolean value) represented by TRUE or FALSE, or by a numerical comparison (e.g., comparison with a prescribed value).

Software, whether referred to as “software”, “firmware”, “middleware”, “microcode” or “hardware description language”, or called by other names, should be interpreted broadly to mean instructions, instruction sets, code, code segments, program codes, programs, subprograms, software modules, applications, software applications, software packages, routines, subroutines, objects, executable files, execution threads, procedures, functions and so on.

In addition, software, commands, information, etc. may be transmitted and received via a transport medium. For example, when software is transmitted from web pages, servers or other remote sources using wired technologies (coaxial cables, fibers, twisted pairs, Digital Subscriber Lines (DSLs), etc.) and/or wireless technologies (infrared ray, microwave, etc.), these wired technologies and/or wireless technologies are included in the definition of the transport medium.

The terms “system” and “network” used in this specification may be used interchangeably.

In this specification, terms like “Base Station (BS)”, “wireless base station”, “eNB”, “gNB”, “cell”, “sector”, “cell group”, “carrier” and “component carrier” may be used interchangeably. A base station is sometimes referred to as terms such as a fixed station, a NodeB, an eNodeB (eNB), an access point, a transmitting point, a receiving point, a femto cell, a small cell and the like.

A base station is capable of accommodating one or more (for example, three) cells (also referred to as sectors). In the case where the base station accommodates a plurality of cells, the entire coverage area of the base station may be divided into a plurality of smaller areas, and each smaller area may provide communication services by using a base station sub-system (for example, a small base station for indoor use (a Remote Radio Head (RRH)). Terms like “cell” and “sector” refer to a part of or an entirety of the coverage area of a base station and/or a sub-system of the base station that provides communication services in this coverage.

In this specification, terms such as “Mobile Station (MS)”, “user terminal”, “User Equipment (UE)”, and “terminal” may be used interchangeably. The mobile station is sometimes referred by those skilled in the art as a user station, a mobile unit, a user unit, a wireless unit, a remote unit, a mobile device, a wireless device, a wireless communication device, a remote device, a mobile user station, an access terminal, a mobile terminal, a wireless terminal, a remote terminal, a handset, a user agent, a mobile client, a client, or some other appropriate terms.

Furthermore, a wireless base station in this specification may also be replaced with a user terminal. For example, for a structure in which communication between a wireless base station and a user terminal is replaced with communication between a plurality of user terminals (Device-to-Device, D2D), the respective manners/embodiments of the present disclosure may also be applied. At this time, functions provided by the first communication device and the second communication device of the above device 800 may be regarded as functions provided by a user terminal. Furthermore, the words “uplink” and “downlink” may also be replaced with “side”. For example, an uplink channel may be replaced with a side channel.

Also, a user terminal in this specification may be replaced with a wireless base station. At this time, functions provided by the above user terminal may be regarded as functions provided by the first communication device and the second communication device.

In this specification, specific actions configured to be performed by the base station sometimes may be performed by its upper nodes in certain cases. Obviously, in a network composed of one or more network nodes having base stations, various actions performed for communication with terminals may be performed by the base stations, one or more network nodes other than the base stations (for example, Mobility Management Entities (MMEs), Serving-Gateways (S-GWs), etc., may be considered, but not limited thereto)), or combinations thereof.

The respective manners/embodiments described in this specification may be used individually or in combinations, and may also be switched and used during execution. In addition, orders of processes, sequences, flow charts and so on of the respective manners/embodiments described in this specification may be re-ordered as long as there is no inconsistency. For example, although various methods have been described in this specification with various units of steps in exemplary orders, the specific orders as described are by no means limitative.

The manners/embodiments described in this specification may be applied to systems that utilize Long Term Evolution (LTE), Advanced Long Term Evolution (LTE-A, LTE-Advanced), Beyond Long Term Evolution (LTE-B, LTE-Beyond), the super 3rd generation mobile communication system (SUPER 3G), Advanced International Mobile Telecommunications (IMT-Advanced), the 4th generation mobile communication system (4G), the 5th generation mobile communication system (5G), Future Radio Access (FRA), New Radio Access Technology (New-RAT), New Radio (NR), New radio access (NX), Future generation radio access (FX), Global System for Mobile communications (GSM®), Code Division Multiple Access 3000 (CDMA 3000), Ultra Mobile Broadband (UMB), IEEE 920.11 (Wi-Fi®), IEEE 920.16 (WiMAX), IEEE 920.20, Ultra-Wide Band (UWB), Bluetooth® and other appropriate wireless communication methods, and/or next-generation systems that are enhanced based on them.

Terms such as “based on” as used in this specification do not mean “based on only”, unless otherwise specified in other paragraphs. In other words, terms such as “based on” mean both “based on only” and “at least based on.”

Any reference to units with designations such as “first”, “second” and so on as used in this specification does not generally limit the quantity or order of these units. These designations may be used in this specification as a convenient method for distinguishing between two or more units. Therefore, reference to a first unit and a second unit does not imply that only two units may be employed, or that the first unit must precedes the second unit in several ways.

Terms such as “deciding (determining)” as used in this specification may encompass a wide variety of actions. The “deciding (determining)” may regard, for example, calculating, computing, processing, deriving, investigating, looking up (e.g., looking up in a table, a database or other data structures), ascertaining, etc. as performing the “deciding (determining)”. In addition, the “deciding (determining)” may also regard receiving (e.g., receiving information), transmitting (e.g., transmitting information), inputting, outputting, accessing (e.g., accessing data in a memory), etc. as performing the “deciding (determining)”. In addition, the “deciding (determining)” may further regard resolving, selecting, choosing, establishing, comparing, etc. as performing the “deciding (determining)”. That is to say, the “deciding (determining)” may regard certain actions as performing the “deciding (determining)”.

As used herein, terms such as “connected”, “coupled”, or any variation thereof mean any direct or indirect connection or coupling between two or more units, and may include the presence of one or more intermediate units between two units that are “connected” or “coupled” to each other. Coupling or connection between the units may be physical, logical or a combination thereof. For example, “connection” may be replaced with “access.” As used in this specification, two units may be considered as being “connected” or “coupled” to each other by using one or more electrical wires, cables and/or printed electrical connections, and, as a number of non-limiting and non-inclusive examples, by using electromagnetic energy having wavelengths in the radio frequency region, microwave region and/or optical (both visible and invisible) region.

When terms such as “including”, “comprising” and variations thereof are used in this specification or the claims, these terms, similar to the term “having”, are also intended to be inclusive. Furthermore, the term “or” as used in this specification or the claims is not an exclusive or.

Although the present disclosure has been described above in detail, it should be obvious to a person skilled in the art that the present disclosure is by no means limited to the embodiments described in this specification. The present disclosure may be implemented with various modifications and alterations without departing from the spirit and scope of the present disclosure defined by the recitations of the claims. Consequently, the description in this specification is for the purpose of illustration, and does not have any limitative meaning to the present disclosure.

What is claimed:

1. A terminal, comprising:
a receiving unit for receiving a sidelink state message from another terminal, the sidelink state message of the other terminal including information about available sidelinks of the other terminal; and
a processing unit for determining an available multi-hop link of the terminal based on the received sidelink state message.

2. The terminal of claim 1, wherein:
a sidelink state message of each terminal includes at least ID information of the terminal and information about sidelinks of more than 1 hop available to the terminal.

3. The terminal of claim 1, wherein:
the processing unit determines sidelink state message of the terminal itself,
the terminal further comprising:
a transmitting unit for transmitting the determined sidelink state message of the terminal itself.

4. The terminal of claim 3, wherein:
the transmitting unit transmits the sidelink state message of the terminal itself in a time period that occurs periodically.

5. The terminal of claim 4, wherein:
each said time period is divided into a plurality of slots,
the transmitting unit transmits the sidelink state message of the terminal itself in one of the plurality of slots.

6. The terminal of claim 4, wherein:
a length of the time period is configured according to a number of terminals to exchange sidelink state messages with each other.

7. The terminal of claim 4, wherein:
the processing unit determines resources for transmitting the sidelink state message of the terminal itself.

8. The terminal of claim 3, wherein:
the transmitting unit transmits the sidelink state message of the terminal itself determined by the processing unit to a resource scheduling device.

9. The terminal of claim 8, wherein:
the transmitting unit transmits the sidelink state message of the terminal itself to the resource scheduling device through high layer signaling.

10. A method performed by a terminal, comprising:
receiving sidelink state messages from another terminal, the sidelink state message including at least information about available sidelinks of the other terminal other than a link with the terminal; and
determining an available multi-hop link of the terminal based on the received sidelink state message.
